(19) United States
(12) Patent Application Publication
(10) Pub. No.: US 2016/0217541 A1
(43) Pub. Date: Jul. 28, 2016

(54) HEALTHCARE-SPECIFIC CREDIT CARD BASED SYSTEM AND METHOD FOR SHIFTING PATIENT HEALTHCARE COST-COLLECTION RISK FROM A HEALTHCARE PROVIDER TO A CREDIT CARD ISSUING COMPANY

(71) Applicants: Robert G. Mahaffey, Las Vegas, NV (US); Rulx Ganthier, JR., Lake Placid, FL (US)

(72) Inventors: Robert G. Mahaffey, Las Vegas, NV (US); Rulx Ganthier, JR., Lake Placid, FL (US)

(21) Appl. No.: 15/071,824

(22) Filed: Mar. 16, 2016

Related U.S. Application Data
(63) Continuation-in-part of application No. 14/045,144, filed on Oct. 3, 2013.
(60) Provisional application No. 61/709,226, filed on Oct. 3, 2012.
(60) Provisional application No. 62/134,741, filed on Mar. 18, 2015.

(51) Int. Cl. G06Q 50/22; G06Q 20/24; G06Q 40/02; G06Q 40/08

(52) U.S. Cl. CPC G06Q 50/22; G06Q 40/08; G06Q 20/24; G06Q 40/025

(57) ABSTRACT

A method for payment of healthcare costs for a patient includes supplying a healthcare provider with a card swipe machine having a card sensor for reading a payment card, a processor for calculating a bill, and a memory storing established discounts and risk payment amounts. A patient utilizing the payment card has a predetermined discount applied to a healthcare services bill. The payment card provider pays to the healthcare provider the discounted bill minus a negotiated risk payment amount for assuming the risk for collecting the payment. The payment card provider invoices the patient for the amount of the billed healthcare services and collects that amount from the patient.

### CROSS-REFERENCE TO RELATED APPLICATION

This U.S. non-provisional utility patent application is a continuation-in-part of co-pending U.S. non-provisional utility patent application Ser. No. 14/045,144, filed on Oct. 3, 2013, which, in turn, claims the benefit of U.S. provisional patent application No. 61/709,226, filed on Oct. 3, 2012. Furthermore, this U.S. non-provisional patent application claims the benefit of U.S. provisional patent application No. 62/134,741, filed on Mar. 18, 2015. All of the above-referenced previously-filed U.S. non-provisional and U.S. provisional patent applications are incorporated-by-reference herein in there entireties.

### FIELD OF THE INVENTION

The present disclosure generally relates to healthcare provider services. More particularly, the present disclosure pertains to a healthcare credit card based system and method for shifting the risk attendant with patient healthcare cost collection from healthcare providers to a healthcare credit card issuer.

### BACKGROUND OF THE INVENTION

As healthcare costs continue to rise, and the provision of healthcare services and patient visits continue to increase, today's healthcare providers often retain significant accounts receivable for the services they provide. The time lag between provision of a healthcare service and reimbursement by the insurance carrier, as well as delays in receiving payments from a patient for any amounts for which the patient is responsible, continue to strain the revenue stream of healthcare providers. The cost of administering and collecting these accounts receivable represents a considerable resource allocation for the provider. Also, the carrying costs generated by these receivables represent a sizable expense for the provider. All healthcare providers, including hospitals, physicians, laboratories, ambulatory surgery centers, diagnostic centers and clinics, are subject to these costs of doing business.

Typically, when a patient receives healthcare services, she is expected to pay any amount not covered by insurance at the time the services are rendered. The payment is generally in the form of a personal check drawn from the patient's bank account, by credit card, or by debit card. In the former case, the check can take several days to clear before the corresponding deposit is made into the provider's bank account. Credit card transactions are typically processed faster—and thus the deposit is credited to the provider's account earlier—when compared to payments by check. Cash payments result in immediate revenue to the provider: however, currently few patients pay for their healthcare services with cash.

With regard to the use of credit cards, the healthcare provider processes the credit card payment, thereby notifying the credit card issuer that the patient has charged the amount due to the credit card. A few days thereafter, this amount is debited to the patient's personal account and the provider's bank account is credited with the amount charged by the patient. The transaction is finally concluded when the patient pays the credit card issuer for the healthcare service. If this payment from the patient is not received within an allotted time, interest charges are assessed against the card holder.

Accordingly, there is a well-recognized, as of yet unmet, need in the art for a novel system and method, which overcomes the drawbacks, limitations and disadvantages of current health payment systems and methods. In particular, it would be highly desirable to provide a healthcare credit card based system and method for effectively shifting the risk attendant with patient healthcare cost collection from healthcare providers to a healthcare credit card issuer.

### SUMMARY OF THE INVENTION

The present disclosure is generally directed to a system and method for payment of patient healthcare costs. In a general implementation, a method includes providing a healthcare provider with a card-reading device (alternatively referred to herein as a “swipe machine” for convenience, but intended to encompass any existing or future equipment or device capable of reading/interpreting information stored on a card) for reading a healthcare payment card presented to the healthcare provider by a patient. Preferably, the card swipe machine is of the type including a card sensor for reading information from a healthcare payment card, a processor for calculating a bill for provided healthcare services, and a memory for storing discounts and risk payment amounts. A healthcare payment card is issued to a patient by a payment card provider. A discount applicable to the patient is established and stored on the card swipe machine, along with a risk payment amount negotiated between the payment card provider and the healthcare provider in a manner enabling the payment card provider to assume the risk of collecting, from the patient, the payment for the healthcare services. The patient is billed for healthcare services provided to the patient, and the healthcare payment card information is read when swiped or otherwise interfaced with the card swipe machine. The patient discount is applied to the billed healthcare services, and the healthcare services bill transaction is transmitted to the payment card provider. The payment card provider then invoices the patient the discounted amount of the billed healthcare services, and remits to the healthcare provider the discounted amount of the billed healthcare services minus the risk payment amount.

In another aspect, the healthcare payment card may include a radio frequency identification device integrated therewith, and the card swipe machine card sensor may read information from the radio frequency identification device.

In still another aspect, the health payment card information is resident within an application hosted on a mobile electronic device of the patient, and the card swipe machine is communicative with the mobile electronic device for transmitting the information from the mobile electronic device to the card swipe machine.

In yet another aspect, the negotiating step may include calculating the risk payment amount for a healthcare services transaction as a percentage of the cost of the healthcare services.

In a still further aspect, the negotiating step may include establishing the risk payment amount as a fixed tee per transaction.

In another aspect, after the remitting step the method may include the step of providing, to the healthcare provider from the card swipe machine, a statement of the discounts provided during the year.

In another aspect, after the issuing step the method may include the step of providing to the patient a regional list of healthcare providers participating in the discounts offered by the healthcare payment card program.

In a still further aspect, after the remitting step the method may include the step of collecting payment for the healthcare services from the patient.

In yet another aspect, a card swipe machine for use facilitating healthcare service payments may include a card sensor for reading a healthcare payment card having information stored thereon, wherein the sensor is able to read at least an identity of a patient presenting the healthcare payment card and an account associated with the patient. A memory may have stored thereon a discount schedule of a plurality of discounts for applying a cost discount to healthcare services rendered by a healthcare provider to the patient and associating one of the discounts previously designated to the patient, and further having stored thereon a risk payment amount for retention by an issuer of the healthcare payment card. A processor may calculate and apply the discount to the healthcare services provided to the patient by the healthcare provider, calculate and apply the risk payment for retention by the healthcare card issuer, and communicate the transaction to the healthcare card provider.

In another aspect, the card sensor may he capable of reading a radio frequency identification device resident on the healthcare payment card.

In still another aspect, the card sensor may be capable of communicating with a patient's mobile electronic device, and the mobile electronic device may transmit at least the patient's identity and account information associated with the account.

In yet another aspect, the card swipe machine may further include a printer for printing a copy of a healthcare services transaction, including at least a cost of the healthcare services provided and the discount for the patient applied to reduce the cost.

In another aspect, the risk payment amount for a healthcare services transaction may be calculated as a percentage of the cost of the healthcare services.

In still another aspect, the risk payment amount may be applied to the healthcare services transaction as a fixed fee.

These and other features, aspects, and advantages of the invention will be further understood and appreciated by those skilled in the art by reference to the following written specification, claims and appended drawings.

### BRIEF DESCRIPTION OF THE DRAWINGS

The invention will now be described, by way of example, with reference to the accompanying drawings, where like numerals denote like elements and in which:

FIG. 1 presents a schematic depiction of a system for effecting payment for healthcare services;

FIG. 2 presents a flowchart representing one implementation of a method of paying for healthcare services;

FIG. 3 presents a block diagram of an apparatus for implementing an implementation/embodiment of the method of FIG. 1; and

FIG. 4 presents a flowchart depicting a further exemplary implementation of a method for paying for healthcare services.

Like reference numerals refer to like parts throughout the various views of the drawings.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the implementations/embodiments disclosed herein are not to be considered as limiting, unless the claims expressly state otherwise.

The implementations of the present invention reside primarily in a novel and non-obvious combination of elements and process steps. So as not to obscure the disclosure with details that will be readily apparent to those skilled in the art, certain conventional elements and steps have been presented with less detail, while the drawings and the specification describe in greater detail other elements and steps pertinent to understanding the embodiments. The presented embodiments are not intended to define limits as to the structures, elements or methods of the inventions, but only to provide exemplary constructions. The embodiments are permissive rather than mandatory and are illustrative rather than exhaustive.

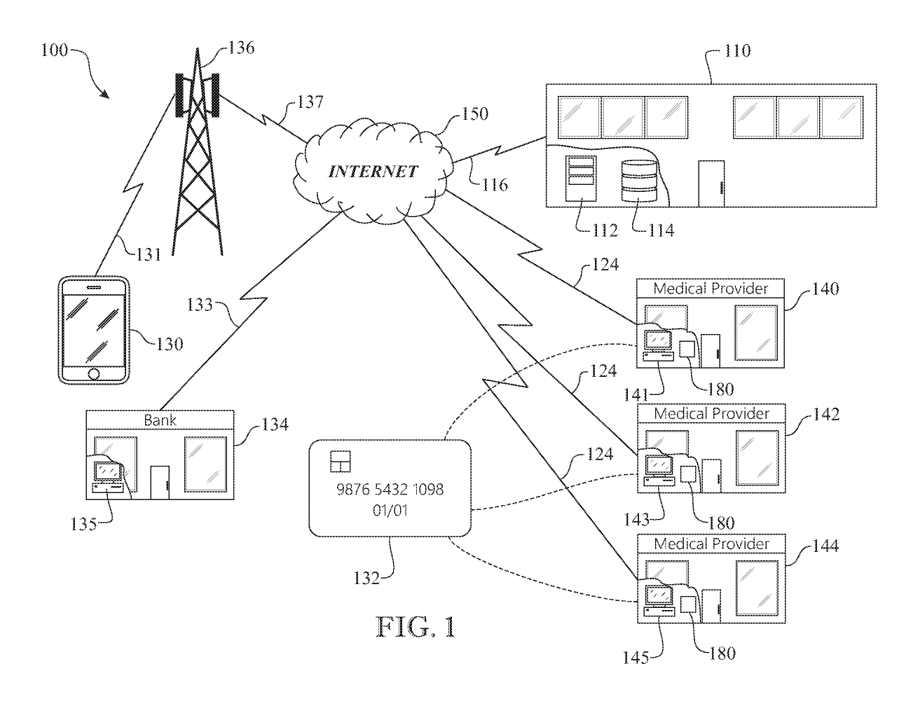

Turning to the drawings, FIG. 1 shows a healthcare payment system 100 utilized by a patient for paying a medical professional, such as a physician for medical consultation or healthcare services, which is one of the preferred implementations of the present invention and illustrates its various components. Healthcare payment system 100 is based at a central office 110 of a payment card provider (PCP). A PCP 110 issues a payment card 132 to individuals for use in making payments for healthcare services. As used herein, a payment card 132 refers to any of the following exemplary card types o any similar vehicle) for making payment by a consumer to a vendor: credit card, debit card, automated teller machine (ATM) card, charge card, stored-value card and fleet card. The PCP central office 110 houses a server 112 executing an executable instruction set for transferring funds from an identified patient's bank account to pay at least a portion of the healthcare services rendered to a patient. The server 112 is further interconnected with a searchable storage medium 114. Server 112 is also connected to the Internet 150 with a communications link 116 for communicating with entities outside of central office 110.

One or more healthcare providers 140, 142, 144, typically physicians, clinics, rehabilitation facilities, urgent care centers, hospitals or other healthcare related facilities, participate in the provision of medical advice and healthcare services to patients requiring care. Each healthcase provider 140, 142, 144 has a corresponding respective network terminal 141, 143 and 145, such as, for example, a personal computer that is further electronically linked to Internet 150 via electronic communication links 124. The network terminals 141, 143, and 145 are also communicatively connected to payment card readers 180, respectively, to facilitate the reading of a payment card 132 to identify the patient and transmit payment authorizations via the PCP 110 for transferring funds from the patient's bank account to the healthcare provider via the PCP 110. The patient's bank 134 has a server/computer 135 which is communicative with the PCP 110 through communication link 133 and the Internet 150.

Additionally, a patient, can also utilize a mobile electronic device 130 such as, but not limited to, a smart phone to effect payment to the healthcare provider without utilizing the physical payment card 132. Known application software is available for a smart mobile electronic device 130 equipped with Near Field Communication (NFC) hardware (or any other available similar technology) to complete payments at NFC-equipped (or alternative technology equipped) terminals, such as payment card readers 180, by placing a patient's mobile electronic device 130 proximate to the payment card readers 180 without requiring the use of the physical payment card 132, by merely incorporating the data from the payment card 132 into the software application. In this manner, the patient can conduct payment transactions at a healthcare provider 140, 142, 144 without necessitating the carrying of the physical payment card 132. All references to use of a payment card 132 herein are deemed to be inclusive of utilization of the NFC-equipped smart mobile electronic device 130 incorporating information of the healthcare payment account associated with the payment card 132.

One exemplary implementation relates to a method 200 of using a healthcare payment card 132 that offers financial assistance (e.g., in the form of a discount) to healthcare consumers when they use the medical services of an enrolled healthcare provider 140, 142, 144 (i.e., a healthcare provider having a business relationship with the healthcare payment card issuer). Any healthcare provider 140, 142, 144, such as, for example, a hospital, physician, surgery center, diagnostic center, funeral home, home health company, physical therapy/rehabilitation facility and nursing home, is eligible to enroll in the plan. Those consumers who use the healthcare payment card 132 include anyone qualifying for the payment card 132 through criteria established by the financial institution responsible for issuing the card 132.

A healthcare provider 140, 142, 144 contracts with a payment card provider 110 or issuer (PCP) and selects a discount percentage that the provider wishes to offer to its patients. After the contract is initiated, each healthcare provider 140, 142, 144 is supplied with a special card swipe machine that automatically discounts the provided service based upon the selected contract discount. Contracts will only be provided to healthcare providers 140, 142, 144 in predefined good standing with applicable federal and state regulations.

Consumers can apply for the healthcare payment card 132 as they do any other credit or debit card. The payment card 132 can he used when services are provided by any healthcare provider 140, 142, 144 enrolled in the program and under contract with the PCP 110 of the healthcare payment card 132.

A patient utilizes the services of a healthcare provider 140, 142, 144 who participates in the MEDACREDIT Program, an exemplary name for the program described herein.

As an example, let's assume that a patient is billed $500.00 for services rendered. After insurance and co-payments are applied, the patient has a remaining out-of-pocket expense of $100.00. The patient may utilize his MEDACREDIT payment card 132 to pay the remaining balance of $100.00.

However, significantly, prior to payment by the patient, a discount is applied to the payment card payment. The discount amount is selected by the healthcare provider 140, 142, 144 as previously designated in a contract between the PCP 110 and the healthcare provider 140, 142, 144.

Merely for the purpose of illustration, an exemplary Discount/Incentive Table follows:

10% discount to patient a id a 10% incentive to paymnent card provider (PCP);

15% discount to patient and a 9% incentive to PCP;

20% discount to patient and an 8% incentive to PCP;

25% discount to patient and a 7% incentive to PCP;

30% discount to patient and a 6% incentive to PCP;

35% discount to patient and a 5% incentive to PCP;

40% discount to patient and a 4% incentive to PCP;

45% discount to patten and a 3% incentive to PCP; and

50% discount to patient and a 2% incentive to PCP

Referring to the above example, the patient has a $100.00 out-of-pocket expense. Assuming the service provider/PCP contract designates a 10% patient discount, PCP 110 then invoices the patient $90.00 (i.e., $100 minus a 10% discount). Upon receipt of the $90 payment from the patient through use of the MEDACREDIT card 132, the PCP 110 pays $80.00 to the healthcare provider 140, 142, 144, thus receiving a 10% incentive as set forth in the exemplary Discount/Incentive table above. The 10% bonus or incentive functions to compensate the PCP 110 for assuming the risk vis-á-vis the patient's payment of the healthcare provider's bill.

As further exemplified by the table above, the lower the discount provided to the patient, the larger the incentive provided to the PCP 110. The incentive decreases as the discount increases since the PCP 110 assumes less risk.

This exemplary implementation presents a desired process to help healthcare consumers cope with the rising cost of healthcare, whether the Patient Protection and Affordable Care Act continues to exist partially, entirely, or if it is eventually stricken or completely changed. Healthcare consumers who take advantage of the MEDACREDIT payment card 132 will receive a discount for healthcare services, providing an economical process for financing one of the most important and expensive aspects of their lives: that is, their health.

The financial institution that develops the payment card 132 creates an innovative low cost system with a perpetual revenue stream and access to additional sources of revenue, such as, for instance, smart device application (apps), cloud technology, etc.

The healthcare providers 140, 142, 144 receive benefits from reduced expenses associated with, for example, materials, postage, in-house and outsourcing of cash collection efforts and, in return, will save millions of dollars that will translate to reduced healthcare costs for consumers.

In light of the ability of retailers/businesses to add a surcharge (e.g., 1.5 to 3.0 percent) for certain card transactions, the MEDACREDIT payment card 132 should be an especially welcome new product for the consumer.

Use of the MEDACREDIT system will reward all healthcare providers 140, 142, 144 who maintain good standing in their professional fields, thereby translating to improved quality of care offered to their patients and improved economic success via improved growth of their business.

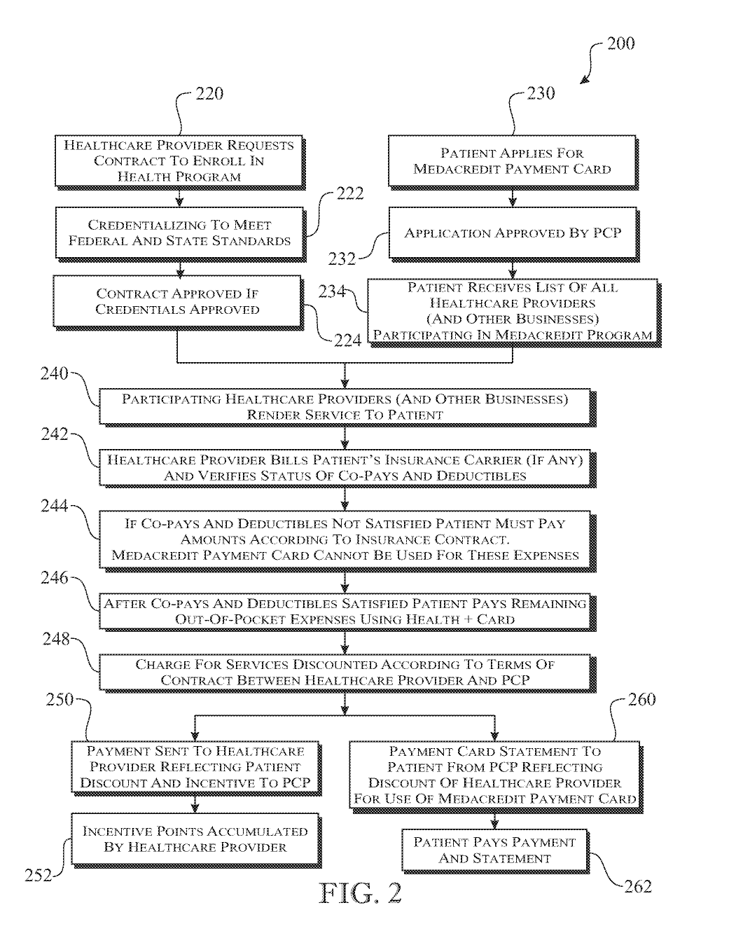

The flow chart of FIG. 2 illustrates a method 200 representing an exemplary implementation of the present invention. At a block 220 a healthcare provider 140, 142, 144 requests a contract with a PCP 110 to enroll in the MEDACREDIT program. Credentialing of the healthcare provider 140, 142 and 144 occurs at block 222, and a contract between the approved healthcare provider 140. 142, 144 and the PCP 110 is approved at block 224 of the process.

Turning our attention to the right-hand side of FIG. 2, at block 230 a patient applies for a MEDACREDIT payment card 132 and the application is approved at block 232. At block 234, the patient receives a list of all healthcare providers 140, 142, 144 participating in the MEDACREDIT program, or a list of other businesses participating in a similar program.

At block 240, enrolled healthcare providers 140. 142, 144 provide a service to the patient. At a block 242 the healthcare provider 140. 142, 144 bills/invoices the patient and determines the status of any co-pay and deductible amounts. Block 244 indicates that any co-pay and deductible amounts that are not satisfied must be paid by the patient, in accordance with an exemplary implementation of the MEDACREDIT program, payment card 132 cannot be used for those expenses.

At block 246, the patient pays the remaining out-of-pocket amount using the MEDACREDIT payment card 132. Block 248 indicates that the actual out-of-pocket charge to the patient is discounted according to the discount schedule defined by the contract between the healthcare provider 140, 142, 144 and the PCP 110.

At block 250, a payment is sent to the healthcare provider 140, 142, 144 by the PCP 110. This payment amount reflects the discount provided to the patient and the incentive provided to the PCP 110. At block 252, incentive points may be accumulated by the healthcare provider 140, 142, 144.

In an application where the payment card 132 is a credit card, a credit card statement is sent to the patient from the PCP 110 at block 260. This statement reflects the discount to the patient for use of the MEDACREDIT payment card 132. At block 262 the patient pays the credit card statement.

Although the steps associated with the method 200 of FIG. 2 have been described in the context of a patient and healthcare provider 140, 142, 144, it will be apparent to those skilled in the art that the teachings of the present invention can also he applied to other businesses that supply goods and/or services to members of the public.

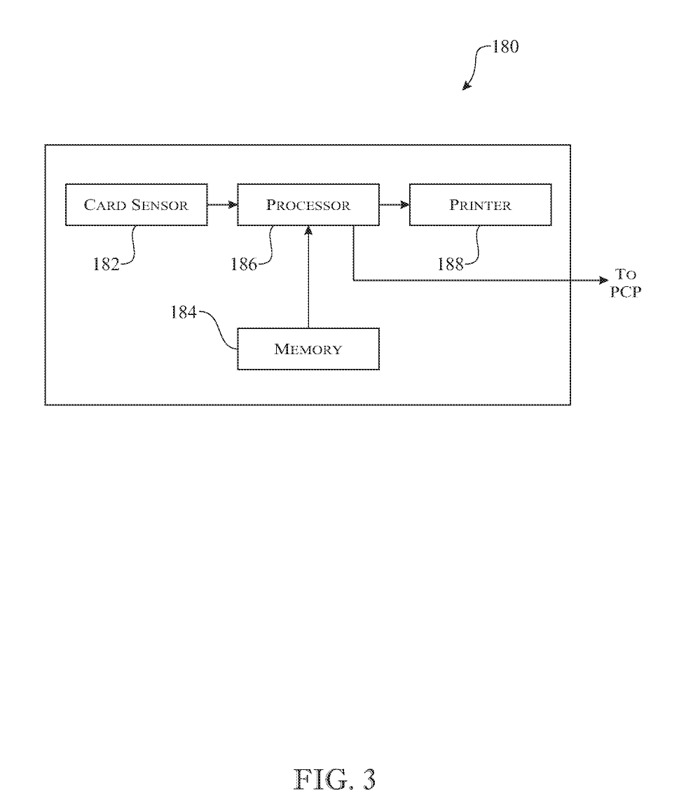

Another aspect of the invention includes a card swipe machine 180 as set forth in the block diagram in FIG. 3. The card swipe machine implements the discount amount agreed to between the PCP 110 and the healthcare provider 140, 142, 144. A card sensor 182 reads the card and determines the identity of the patient. The discount amount is stored in a memory 184 and a processor 186 calculates the amount due based on that discount amount. The discount amount is previously agreed to and set forth in a contract between the healthcare provider 140, 142, 144 and the PCP 110. Storing this discount amount and programming the swipe machine 180 to implement the agreed discount eliminates errors that might otherwise occur if the discounted amount was manually entered for each transaction. This feature also eliminates discrimination in the applied discount, where, for example, the healthcare provider 140, 142, 144 offers a first discount to certain patients and a second lower discount to other patients.

A processor 186, responsive to the memory 184 and the card sensor 182, calculates the amount due from the patient, and a printer 188 prints a receipt after payment of the amount due. The amount due is also transmitted to the PCP 110 for use in preparing the patient's statement.

At the end of each year the system/swipe card machine 180 provides a statement to the healthcare providers 140, 142, 144 indicating the discounts provided during the year and also the earned incentive (referred to in block 252 of FIG. 2).

In another implementation, the discount scheme of the present invention can be applied to the payment of deductible and co-pay amounts upon approval of the insurance carrier.

As described above, in a preferred embodiment 400 the healthcare provider 140, 142, 144 determines/defines the amount of discount granted to the PCP 110, in return for the PCP 110 bearing the risk of non-payment by the patient.

Beneficially, the method 400 and the swipe card machine 180 eliminate the cost of collection efforts by healthcare providers 140, 142, 144, which in turn will reduce healthcare expenses.

Since only healthcare providers 140, 142, 144 who have contracted with a PCP 110 will be using the method identified by reference numeral 400; regional lists of those providers can be provided to patients, whom would naturally he encouraged to use the listed providers. The discount method 400 and associated card 132 may be beneficial to new physicians to use in attracting new patients. The card 132 and its attendant discount methodology can be used not only by physicians in private practice, but also hospital-based physicians such as pathologists, radiologist, anesthesiologists, and emergency room physicians.

Patients' use of the card 132 can be utilized to track revenue and market data. Employers can offer the card 132 to employees as a component of their employee benefits package. The PCP 110 may offer the card 132 to patients with no fee (e.g., no annual fee) or there may be a fee associated with the card.

Although described in the context of a patient/healthcare provider 140, 142, 144, the method of the present invention can also be applied, for example, to the following services: retail, transportation, industrial, food/restaurants, farming, construction/development, and many other financial/banking transactions.

When the present invention is applied to debit cards, the PCP 110 assumes a lower risk than they would with a credit card, and thus the PCP 110 discount should be correspondingly less.

As applied to the medical field, the present invention has been described in the context of traditional healthcare providers 140, 142, 144, such as physicians in private practice. But the various embodiments of the invention can also be practiced by pharmacists, hospitals, rehabilitation centers, nursing homes, diagnostic centers, medical spas, hospice caregivers, funeral homes and the like. As applied to the method 200 illustrated in FIG. 2, these businesses must also be determined to be in “good standing” before contracting with the card-issuing company.

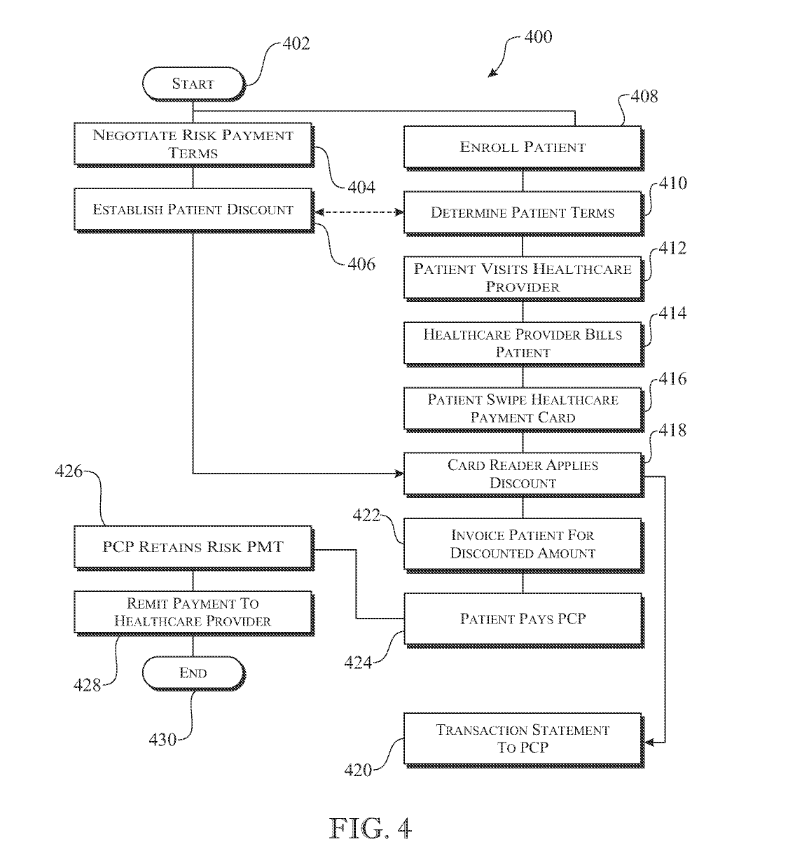

In another exemplary implementation of the method 400 illustrated in FIG. 4, a patient visits a healthcare facility, receives healthcare services, and is subsequently billed, for example, $500 for the services. The patient pays the bill using the healthcare credit card 132 previously described above. By using the healthcare credit card 132 the bill is discounted by 15% (for example) so, in fact, the patient's credit card statement reflects an amount due of $425 (i.e., $500−((0.15)×($500)). The software-driven program that controls the healthcare credit card system 100 calculates an amount based upon the amount to be billed to, and paid by, the patient. In the illustrated example this amount is 5% of $425 (or $21.25). Accordingly, the patient is billed $425 for the healthcare services rendered and pays this amount.

The credit card company pays $403.75 (i.e., ($500−(0.15×$500))×0.95) of the balance after applying the 15% discount to the healthcare provider 140, 142, 144. The credit card issuer retains the 5% discount of $21.25 as compensation for the risk the credit card company assumed for non-payment by the patient.

A total 20% discount was used in the example above. However, each healthcare provider 140, 142, 144 may negotiate the specific discounts that will be applied in the system of the present invention. In accordance with the exemplary implementation associated with the method of FIG. 2, the discount and payment were pre-determined based upon a predefined table/chart. For the method 400 illustrated in the FIG. 4, the discount to the patient is determined by the healthcare provider 140, 142, 144 and can be a varying percentage or a flat amount, as they see fit. The payment to the credit card company is also negotiated between the provider and the credit card company, in lieu of being a pre-determined percentage based upon the discount given to the patient.

As illustrated, the method for paying for healthcare services in FIG. 4 begins at block 402. At block 404, the PCP 110 and a healthcare provider 140, 142, 144 negotiate to establish payment terms, and in particular, a risk payment term. The risk payment term is defined as the amount of funds that the PCP 110 retains resulting from the amount of payment remitted by the patient after application of the patient discount. The risk payment term can either be a fixed fee per transaction or a percentage of the amount remitted by the patient. The risk payment term as described hereinabove compensates the PCP 110 for assuming the risk of collecting the healthcare service fees from the patient. In block 406, the various patient discount schedules are established for application to the patients of the healthcare provider 140, 142, 144.

At block 408, an individual is established as a patient of the healthcare provider 140, 142, 144 and subsequently enrolled in the healthcare payment plan. At block 410, the program terms under the healthcare payment plan for the enrolled patient are determined. Such determining factors may include, for example, whether the patient is an individual under a private insurance company, whether the patient is an employee of a company with a group health plan, the patient's prior medical history, the patient's prior payment history, etc. Based upon these program terms, the particular terms of the discount schedule from block 406 applicable to the patient may be determined.

At block 412, the patient visits the healthcare provider 140, 142, 144 for healthcare services related to an illness, injury, etc. Once the healthcare provider 140, 142, 144 has provided the necessary services, the patient is billed at block 414, which typically coincides with the end of the healthcare service appointment. At this time, the patient swipes the healthcare payment card 132 through the payment card reader 180 at block 416. Those practiced in the art will also understand that the physical card 132 does not require a particular swipe action to read the information from the card, but can also be read from a radio frequency identification chip on the card or transmitted by the patient's mobile electronic device 130 executing a payment application as described above.

At block 418, the payment card reader 180 that has stored in its memory 184 the identification of the various patients and their associated discounts from the discount schedule established in block 406, applies the relevant discount and risk payment terms to the charges for the healthcare services provided by the healthcare provider 140, 142, 144. At this point in the process, a transaction statement is printed by the printer 188 of the card reader 180 and provided to the patient, displaying the patient discount and total amount due. Concurrently, the transaction statement detailing the healthcare services provided at the appointment, the patient discount, and the associated risk payment are transmitted to the PCP 110, at block 420, and at which time the PCP 110 assumes the risk of collecting the billed amount from the patient.

At block 422, the PCP 110 invoices the patient for the amount of the discounted healthcare services. At block 424, the patient remits to the PCP 110 the discounted amount for the healthcare services established in block 418. At block 426, the PCP 110 retains the risk payment negotiated with the healthcare provider 140, 142, 144 at block 404, and then at block 428 remits to the healthcare provider 140, 142, 144 those amounts due for the healthcare services (less the patient discount of block 406 and the risk payment of block 404) rendered by the healthcare provider 140, 142, 144, regardless of whether the PCP 110 has yet collected those payments from the patient. The process ends at block 430. Those practiced in the art will recognize that although the process 400 describes a single patient visit to a healthcare provider 140, 142, 144, a plurality of charges for healthcare services can be processed in parallel—not necessarily in series.

The healthcare card can also provide patient information to the healthcare provider 140, 142, 144, including: blood type, organ donor information; allergies; particular medical directives; date of birth; eye color; weight; height; physician names; religion; social security number; home/cell telephone number; and physical address.

The credit card issuer can provide an annual tax report to the healthcare providers 140, 142, 144. Providers can use information to determine whether discounts that were provided to consumers can qualify as indigent care write offs.

A verification statement may he sent to the healthcare providers 140, 142, 144 and the credit card issuer, displaying discounts applied, payments made, and monies owed to the healthcare providers 140, 142, 144.

It is generally known that insurance carriers do not permit healthcare providers 140, 142, 144 to discount the cost of co-pays or deductibles to their patients. Significantly, in accordance with the present invention the discount is applied through a credit card and not directly by a healthcare provider 140, 142, 144. Thus, presumably the insurance carriers would have no grounds to prohibit such discounts. It is noteworthy that insurance carriers currently allow cash rewards on credits for services provided and, thus, the payments associated with methods of the present invention would likely be considered permissible.

The healthcare payment card system 100 also has adequate flexibility to add partnerships with other healthcare-related enterprises. For instance, in the case where a healthcare provider 140, 142, 144 utilizing the healthcare card 132 desires, another company may be added to the card (e.g., a pharmacy chain). The pharmacy chain can add its own discount amount to the card. The discounted amount is not necessarily required to match the discount provided by the healthcare provider 140, 142, 144. Sample services that can be added_{;} for example, may include: pharmacy services; hospice care, home healthcare, nursing home expenses and funeral home expenses, to name just a few.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

While the invention has been described with reference to preferred embodiments, it will be understood by those skilled in the art that various changes may be made and equivalent elements may be substituted for elements thereof without departing from the scope of the present invention. The scope of the present invention further includes any combination of the elements from the various embodiments set forth. In addition, modifications may be made to adapt a particular situation to the teachings of the present invention without departing from its essential scope. Therefore, it is intended that the invention not be limited to the particular embodiment disclosed as the best mode contemplated for carrying out this invention, but that the invention will include all embodiments falling within the scope of the appended claims.

What is claimed is:

1. A method for payment of healthcare costs, comprising the steps of:
providing to a healthcare provider a card swipe machine for reading a healthcare payment card presented to the healthcare provider by a patient, the card swipe machine of the type including a card sensor for reading information from a healthcare payment card, a processor for calculating a bill for healthcare services, and a memory for storing discounts and risk payment amounts;
issuing a healthcare payment card to a patient by a payment card provider;
establishing a discount applicable to the patient and storing the discount on the cardswipe machine;
negotiating between the payment card provider and the healthcare provider a risk payment amount for the payment card provider to assume the risk of collecting from the patient the payment for the healthcare services and storing the risk payment amount on the card swipe machine;
billing the patient for healthcare services provided to the patient;
reading the healthcare payment card information when swiped in the card swipe machine;
applying the patient discount to the bill d healthcare services;
transmitting the healthcare services bill transaction to the payment card provider;
invoicing to the patient by the payment card provider the discounted amount of the billed healthcare services; and
remitting to the healthcare provider the discounted amount of the billed healthcare services minus the risk payment amount.

2. The method for payment of healthcare costs according to claim 1 wherein the healthcare payment card includes a radio frequency identification device thereon and wherein the card swipe machine card sensor can read information from the radio frequency identification device.

3. The method for payment of healthcare costs according to claim 1 wherein the healthcare payment card information is resident within an application hosted on a mobile electronic device of the patient, and further where in the card swipe machine is communicative with the mobile electronic device for transmitting the information from the mobile electronic device to the card swipe machine.

4. The method for payment of healthcare costs according to claim 1 wherein in the negotiating step the risk payment amount for a healthcare services transaction is calculated as a percentage of the cost of the healthcare services.

5. The method for payment of healthcare costs according to claim 1 wherein in the negotiating step the risk payment amount is established as a fixed fee per transaction,

6. The method for payment of healthcare costs according to claim 1 further including, after the remitting step, the step of providing to the healthcare provider from the card swipe machine a statement of the discounts provided during the year.

7. The method for payment of healthcare costs according to claim 1 further including, after the issuing step, the step of providing to the patient a regional list of healthcare providers participating in the discounts offered by the healthcare payment card program.

8. The method for payment of healthcare costs according to claim 1 further including, after the remitting step, the step of collecting payment for the healthcare services from the patient.

9. A card swipe machine for use in facilitating healthcare service payments, said card swipe machine comprising:
a card sensor for reading a healthcare payment card having information stored thereon, said sensor able to read at least an identity of a patient presenting the healthcare payment card and an account associated with the patient;
a memory having stored thereon a discount schedule of a plurality of discounts for applying a cost discount to healthcare services rendered by a healthcare provider to the patient, and associating one of said discounts previously designated to the patient and further having stored thereon a risk payment amount for retention by an issuer of the healthcare payment card; and
a processor for calculating and applying the discount to the healthcare services provided to the patient by the healthcare provider, for calculating and applying the risk payment for retention by the healthcare card issuer, and for communicating the transaction to the healthcare card provider.

10. The card swipe machine according to claim 9 wherein said card sensor is capable of reading a radio frequency identification device resident on the healthcare payment card.

11. The card swipe machine according to claim 9 wherein said card sensor is capable of communicating with a patient's mobile electronic device and wherein the mobile electronic device transmits at least the patient's identity and account information associated with the account.

12. The card swipe machine according to claim 9 further including a printer for printing a copy of a healthcare services transaction including at least a cost of the healthcare services provided and the discount for the patient applied to reduce the cost.

13. The card swipe machine according to claim 9 wherein the risk payment amount for a healthcare services transaction is calculated as a percentage of the cost of the healthcare services.

14. The card swipe machine according to claim 9 wherein the risk payment amount is applied to the healthcare services transaction as a fixed fee.
